(19) United States
(12) Patent Application Publication
(10) Pub. No.: US 2025/0361945 A1
(43) Pub. Date: Nov. 27, 2025

(54) PRESSURE EQUALIZATION APPARATUS

(71) Applicant: Carl Freudenberg KG, Weinheim (DE)

(72) Inventors: Michael SÖNDGEN, Bensheim (DE); Christian KLEINKE, Darmstadt (DE); Adrian BAUR, Mannheim (DE)

(21) Appl. No.: 18/906,226

(22) Filed: Oct. 4, 2024

(30) Foreign Application Priority Data
May 22, 2024 (DE) 10 2024 114 268.5

(51) Int. Cl. F16K 17/30

(52) U.S. Cl. CPC F16K 17/30; F16K 2200/30

(57) ABSTRACT

A pressure equalization apparatus, including a housing with a gas passage opening which is assigned a valve with a valve body which is loaded with spring force by a spring. The valve body is held by the spring in a holding position, in which the valve body makes sealing contact with a valve seat. The valve body is configured to be snapped in a manner which is dependent on a differential pressure and by the spring force of the spring into an open position, in which the valve body is open and lifted up from the valve seat.

### CROSS REFERENCE TO RELATED APPLICATIONS

This application claims benefit to German Patent Application No. DE 10 2024 114 268.5, filed on May 22, 2024, which is hereby incorporated by reference herein.

### FIELD

The invention relates to a pressure equalization apparatus.

### BACKGROUND

DE 10 2017 003 360 B3 has disclosed a pressure equalization apparatus for a machine housing. The previously known pressure equalization apparatus has an inner side, an outer side and a cage, with a gas passage opening, the gas passage opening connecting the inner side and the outer side in a flow-conducting manner dependent on the differential pressure. The gas passage opening is covered by a gas-permeable membrane which is assigned a pressure relief valve, configured as a rupture protection means, in a functional parallel circuit.

WO 2011/161 512 A1 has disclosed a further pressure equalization apparatus. The pressure equalization apparatus comprises a housing with a gas passage opening which is assigned a valve with a valve body which is loaded with spring force by way of a helical compression spring. The helical compression spring is of cylindrical configuration and has a plurality of spring turns which are arranged at an axial spacing adjacently with respect to one another. The valve body is held by way of the helical compression spring in a holding position, in which the valve body makes sealing contact with a valve seat. The valve body can be steadily moved into an open position counter to the spring force of the helical compression spring in a manner which is dependent on the differential pressure. By virtue of the fact that the valve body lifts up from the valve seat first of all only gradually and subsequently steadily, the opening cross section of the gas passage opening is released correspondingly gradually and steadily. The movement of the valve body is exclusively dependent on the differential pressure which works counter to the spring force of the helical compression spring. The valve body is not given further assistance during its opening. It is to be noted here that, in the case of the occurrence of sudden pressure peaks within a housing, to which the previously known pressure equalization apparatus is connected, the valve body releases the opening cross section of the gas passage opening only slowly. This is not very satisfactory for a dissipation of pressure peaks in the interior of the housing which is as immediate and complete as possible.

Moreover, the previously known pressure equalization apparatus has a comparatively complicated construction, which is not very satisfactory in terms of manufacturing technology and economy. The multiple-turn helical compression spring has large dimensions in the axial direction, with the result that the pressure equalization apparatus is also of large overall design in the axial direction.

### SUMMARY

In an embodiment, the present disclosure provides a pressure equalization apparatus, comprising a housing with a gas passage opening which is assigned a valve with a valve body which is loaded with spring force by a spring. The valve body is held by the spring in a holding position, in which the valve body makes sealing contact with a valve seat. The valve body is configured to be snapped in a manner which is dependent on a differential pressure and by the spring force of the spring into an open position, in which the valve body is open and lifted up from the valve seat.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIGS. 1a to 1d show a method of operation of a pressure equalization apparatus according to the present disclosure;

FIG. 2 shows a pressure equalization apparatus during its use as intended; and

FIG. 3 shows the pressure equalization apparatus from FIG. 1 after pressure equalization has taken place, with a valve body in an open position.

### DETAILED DESCRIPTION

In an embodiment, the present disclosure provides a pressure equalization apparatus of the type mentioned at the outset in such a way that it is capable within a very short time of completely dissipating suddenly occurring pressure peaks. The pressure equalization apparatus is therefore intended to enable a very rapid pressure equalization by virtue of the fact that it can be flowed through highly rapidly by volumetric flows which are as high as possible.

In order to achieve the foregoing, a gas equalization apparatus is provided, comprising a housing with a gas passage opening which is assigned a valve with a valve body which is loaded with spring force by way of a spring, the valve body being held by way of the spring in a holding position, in which the valve body makes sealing contact with a valve seat, and it being possible for the valve body to be snapped in a manner which is dependent on the differential pressure and by way of the spring force of the spring into an open position, in which it is open and lifted up from the valve seat.

It is advantageous here that the opening cross section of the gas passage opening is not released gradually and subsequently steadily, as described above in conjunction with the prior art, but rather virtually instantly and completely by way of the spring element of snappable configuration. Suddenly occurring pressure peaks in the interior of a machine element, for example of a battery housing, to which the pressure equalization apparatus is connected, can be completely dissipated within a very short time by way of the spring of snappable configuration. The opening pressure of the valve and the movement sequence of the valve body can be set by way of an appropriate selection of the spring. During the snapping action and afterward, the spring actively assists the differential pressure which prevails at the valve body, in order to accelerate the opening operation of the valve body.

As mentioned at the outset, the above-described pressure equalization apparatus can be assigned a gas-permeable membrane in a functional parallel circuit.

It can be provided in accordance with one advantageous embodiment that the spring is configured as a tension spring. As will be explained later in even greater detail, a spring of this type is subjected to a tensile load during the use as intended of the pressure equalization apparatus. As a result, the spring pulls the valve body onto its valve seat in a sealing manner.

The spring is then situated in a first metastable and preloaded installed state in the pressure equalization apparatus.

If the internal pressure within the housing which acts on the inner side of the valve body is below a critical threshold value, the spring holds the valve body in its holding position.

If, in contrast, the pressure within the housing rises above a critical threshold value, the valve body which lifts up from the valve seat takes the spring with it out of its first metastable and preloaded installed state until a functionally unstable changing region is reached and the spring snaps over. The unstable changing region is passed through within a very short time, the spring not having any mechanical stability in the changing region. While snapping over, the spring actively assists the opening operation of the valve body together with the internal pressure, with the result that the valve body lifts up from the valve seat within a very short time and releases the maximum opening cross section of the gas passage opening. A second metastable state of the spring is then achieved which the spring has in the case of a fully open valve body.

The spring can be configured as a leaf spring. A spring of this type functions in a similar manner to a hair clip which is configured such that it can likewise snap between a holding position and an open position.

The opening pressure of the valve and the movement sequence of the valve body can be set by way of an appropriate selection of the spring, as has already been stated above. The geometric characteristic variables of the leaf spring have a direct influence on the use properties of the valve, with the result that specific customer specifications can be implemented by way of a corresponding selection of the spring.

Moreover, it is advantageous that the pressure equalization apparatus has a simple construction with a small number of parts and, as a result, can be produced simply and inexpensively in terms of manufacturing and economy. The spring which is configured as a leaf spring has only a very low overall height in the direction of its spring travel, with the result that the entire pressure equalization apparatus also has compact dimensions in this direction.

It can be provided in accordance with an advantageous embodiment that the spring comprises a spring steel. A spring of this type can be produced simply and inexpensively in different specifications. Moreover, it has unchangingly satisfactory use properties during a long service life. In particular, it does not relax even in the case of a long service life.

The spring has a stable state resulting from the manufacturing process. The spring is free from stresses in this state due to the manufacturing process.

In the case of an open valve body, the spring has a second metastable state. It holds the valve body in its open position with a maximum opened passage cross section through the gas passage opening.

In the installed state of the spring and during the use as intended of the pressure equalization apparatus in the case of a closed valve body, the spring is arranged under elastic preload in a metastable state between the housing and the valve body and therefore has the first metastable preloaded installed state. This preloaded installed state ensures that the valve body and the valve seat make sealing contact in the holding position.

In the opening direction of the valve body, the functionally unstable changing region is arranged between the first metastable preloaded installed state and the second metastable state, in which changing region the spring can be snapped over from the installed state into the second metastable state. When the unstable changing region is passed through by the spring, due to an undesirably high positive pressure in the housing, to which the pressure equalization apparatus is connected, the tensile force of the spring which has initially held the valve body in its holding position changes into a compression force which assists the effect of the internal pressure in the interior of the housing. The compression force of the spring and the internal pressure together move the valve body within a very short time into the open position.

During the use as intended of the pressure equalization element, the valve body has in practice only two positions. Either the valve body and the valve seat bear sealingly against one another, or the valve body is lifted up from the valve seat to a maximum extent, in order to release the maximum opening cross section through the gas passage opening.

The spring and the valve body are connected by means of a connecting device.

The connecting device can be formed by way of a journal.

The connecting device and the valve body can be configured in one piece and from the same material. The construction of the pressure equalization apparatus with a small number of parts is assisted as a result.

The valve body can comprise a tough polymeric material. It is advantageous here that the valve body has only a small mass and, resulting from this, only a small mass moment of inertia when it is moved out of its holding position into the open position. As a result of the only small mass moment of inertia, the valve body reacts virtually immediately as soon as the unstable changing region is passed through by the spring and the valve body snaps into the open position as a result of the internal pressure and the spring which assists the effect of the internal pressure.

On its side which faces the valve seat, the valve body can have a seal which makes sealing contact with the valve seat under elastic preload in the case of a closed gas passage opening.

The seal can comprise a rubber-elastic seal material. Seals of this type are well known and are inexpensively available in many specifications.

The housing and the valve seat can be configured in one piece. It is advantageous here that the pressure equalization apparatus has a small number of parts, is inexpensive to produce and is simple to assemble.

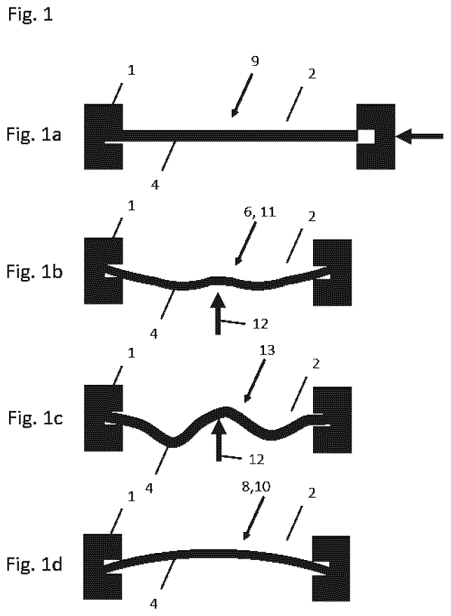

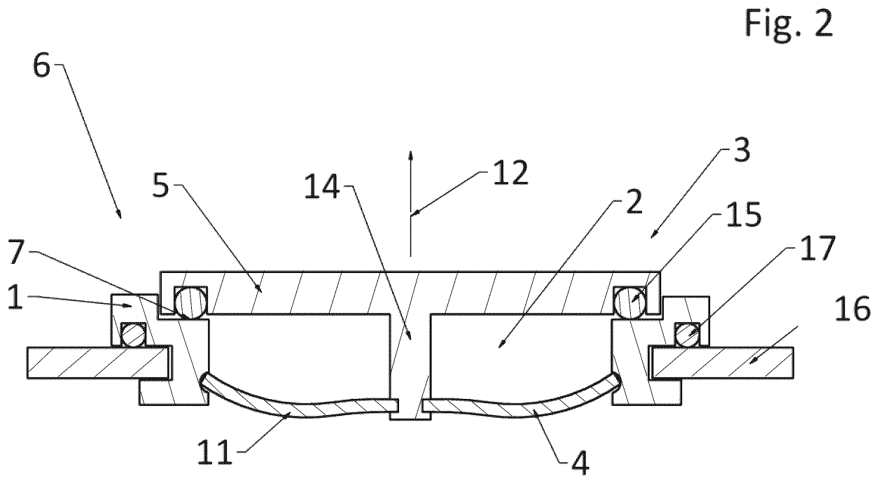

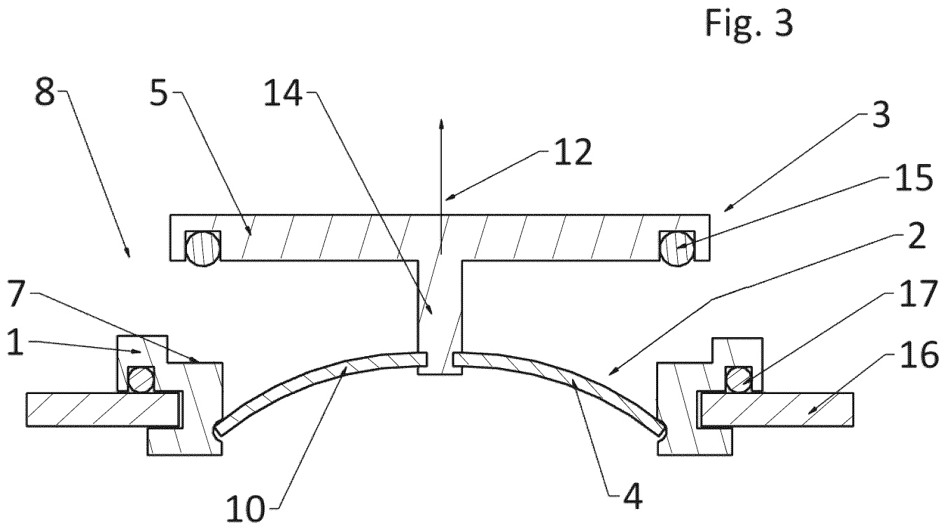

FIGS. 1a to 1d diagrammatically show the method of operation of the pressure equalization apparatus from FIGS. 2 and 3.

FIG. 1a shows the spring 4 as manufactured. The spring 4 is stress-free and has the stable state 9.

FIG. 1b shows the spring 4 installed into the pressure equalization apparatus. Within the housing 1, the internal pressure has an uncritical value. The spring 4 is in its first metastable preloaded installed state 11.

In FIG. 1c, the pressure in the interior of the housing 1 has increased up to a critical threshold value. The spring 4 is moved out of its first metastable preloaded installed state 11 which is shown in FIG. 1b into the changing region 13. In the changing region 13, the spring 4 is situated in an unstable state. The changing region 13 is passed through within a very short time.

In FIG. 1d, the spring 4 has moved out of the changing region 13 into the second metastable state 10 as a result of its spring force and the internal pressure in the housing. The passage through the gas passage opening 2 is at its maximum, and the valve body 5 is situated in the open position 8.

The movement direction of the spring 4 corresponds to the opening direction 12 of the valve body 5.

FIGS. 2 and 3 show one exemplary embodiment of the pressure equalization apparatus according to the present disclosure. The pressure equalization apparatus has a simple construction with a low number of parts.

The pressure equalization apparatus comprises the housing 1 which is configured in one piece with the valve seat 7. The spring 4 which is configured as a tension spring and has the form of a leaf spring is arranged in the housing 1, as a result of which the pressure equalization apparatus has compact axial dimensions. In the exemplary embodiment which is shown here, the spring 4 comprises a spring steel.

The spring 4 is received in a metastably preloaded manner on the edge side in the housing 1, as also shown in FIG. 1b.

In addition to the valve seat 7, the valve body 5 which is loaded with spring force by way of the spring 4 and is connected to the spring 4 by way of the connecting device 14 of pin-shaped configuration is part of the valve 3.

In the exemplary embodiment which is shown here, the valve body 5 and the connecting device 14 are configured so as to merge into one another in one piece and from the same material, and comprise a tough polymeric material. As a result, the mass of the unit comprising the valve body 5 and the connecting device 14 is low, as is the mass moment of inertia of the unit, with the result that, after opening and passing through the unstable changing region 13 (cf. FIG. 1c), the valve body 5 snaps within a very short time from its holding position 6 into its open position 8 and therefore into the second metastable state 10 (cf. FIG. 1d).

The sealing action between the valve body 5 and the valve seat 7 takes place by way of the seal 15 which comprises a rubber-elastic seal material.

FIG. 2 shows the pressure equalization apparatus with the valve body 5 loaded with spring force in the holding position 6.

The spring 4 is deformed from its state which is stress-free and stable due to the manufacturing process (cf. FIG. 1a) into the first metastable preloaded installed state 11 (cf. FIG. 1b).

In the installed state, in the case of a closed valve body 5, the spring 4 is arranged between the housing 1 and the valve body 5 in a manner which is preloaded elastically with a tensile force.

The functionally unstable changing region 13 of the spring 4 is shown in FIG. 1c.

The second metastable state 10 with a completely open valve body 5 is shown in FIG. 3. The opening cross section of the gas passage opening 2 is at a maximum.

The following is stated in respect of the function:

In the exemplary embodiment which is shown, the pressure equalization apparatus is inserted in a housing wall 16 of a machine element, for example in the housing wall 16 of a battery housing. The connection between the pressure equalization apparatus and the housing wall 16 can take place by way of a customary connection, for example by way of a latching connection, a screw connection or a bayonet lock.

During the customary use as intended of the pressure equalization apparatus, the spring 4 which is configured as a tensile leaf spring pulls the valve body 5 sealingly onto the valve seat 7.

In order for it to be possible for sufficient tensile force to be transmitted to the valve body 5 by means of the connecting device 14, the spring 4 is preloaded in the installed state 11. The preloading is achieved by virtue of the fact that the spring 4 is moved out of its first state 9 into the first metastable preloaded installed state 11 during the assembly of the pressure equalization apparatus.

The valve 3 is closed below a critical positive pressure within the machine housing. As a result, the opening cross section of the gas passage opening 2 is also closed.

If a critical positive pressure is reached within the machine housing, the valve body 5 lifts off from the valve seat 7 due to the differential pressure and, as a result, moves the spring 4 from the initial first metastable preloaded installed state 11 into the unstable changing region 13. When the unstable changing region 13 has been passed through, the tensile force of the spring 4 reverses into a compression force and assists the positive pressure from the interior of the machine housing during the rapid opening of the valve body 5, with the result that the maximum opening cross section of the gas passage opening 2 is released by way of the valve body 5 snapping into the open position 8 within a very short time. The open position 8 and the gas passage opening 2 with a maximum opening cross section are shown in FIG. 3.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A pressure equalization apparatus, comprising:
a housing with a gas passage opening which is assigned a valve with a valve body which is loaded with spring force by a spring, the valve body being held by the spring in a holding position, in which the valve body makes sealing contact with a valve seat, and the valve body being configured to be snapped in a manner which is dependent on a differential pressure and by the spring force of the spring into an open position, in which the valve body is open and lifted up from the valve seat.

2. The pressure equalization apparatus as claimed in claim 1, wherein the spring is configured as a tension spring.

3. The pressure equalization apparatus as claimed in claim 1, wherein the spring is configured as a leaf spring.

4. The pressure equalization apparatus as claimed in claim 1, wherein the spring comprises a spring steel.

5. The pressure equalization apparatus as claimed in claim 1, wherein the spring has a stable state due to a manufacturing process.

6. The pressure equalization apparatus as claimed in claim 1, wherein, in an installed state in which the valve body is closed, the spring is arranged under elastic preload between the housing and the valve body and has a first metastable preloaded installed state.

7. The pressure equalization apparatus as claimed in claim 6, wherein, in a case of an open valve body, the spring has a second metastable state.

8. The pressure equalization apparatus as claimed in claim 7, wherein, in an opening direction of the valve body, a functionally unstable changing region is arranged between the first metastable preloaded installed state and the second metastable state, in which changing region the spring is configured to be snapped over from the installed state into the second metastable state.

9. The pressure equalization apparatus as claimed in claim 1, wherein the spring and the valve body are connected by a connecting device.

10. The pressure equalization apparatus as claimed in claim 9, wherein the connecting device is formed by a journal.

11. The pressure equalization device as claimed in claim 9, wherein the connecting device and the valve body are configured in one piece from the same material.

12. The pressure equalization apparatus as claimed in claim 1, wherein the valve body comprises a tough polymeric material.

13. The pressure equalization apparatus as claimed in claim 1, wherein, on a side which faces the valve seat, the valve body has a seal which makes sealing contact with the valve seat in a case of a closed gas passage opening.

14. The pressure equalization apparatus as claimed in claim 13, wherein the seal comprises a rubber-elastic seal material.

15. The pressure equalization apparatus as claimed in claim 1, wherein the housing and the valve seat are configured in one piece.
